(19) United States
(12) Patent Application Publication
(10) Pub. No.: US 2022/0077733 A1
(43) Pub. Date: Mar. 10, 2022

(54) ROTOR FOR ROTATING ELECTRIC MACHINE AND METHOD OF MANUFACTURING THE SAME

(71) Applicant: Mitsubishi Electric Corporation, Tokyo (JP)

(72) Inventor: Moriyuki HAZEYAMA, Tokyo (JP)

(73) Assignee: Mitsubishi Electric Corporation, Tokyo (JP)

(21) Appl. No.: 17/417,754

(22) PCT Filed: Dec. 26, 2019
(86) PCT No.: PCT/JP2019/051159

§ 371 Date: Jun. 24, 2021

(30) Foreign Application Priority Data
Feb. 12, 2019 (JP) 2019-022336

(51) Int. Cl. H02K 1/27; H02K 15/03

(52) U.S. Cl. CPC H02K 1/276; H02K 2213/03; H02K 15/03

(57) ABSTRACT

To provide a rotor for a rotating electric machine, which can improve the efficiency of the rotating electric machine, provided is the rotor for a rotating electric machine, including: a rotor core having a plurality of magnet insertion holes; and a plurality of permanent magnets wherein the plurality of permanent magnets are classified into a first permanent magnet having a dimension in a thickness direction which is within a range of a set tolerance and smaller than a set value, and a second permanent magnet having a dimension in the thickness direction which is within the range of the set tolerance and larger than the set value, and wherein the plurality of magnet insertion holes are classified into a first magnet insertion hole into which the first permanent magnet is inserted, and a second magnet insertion hole, the second permanent magnet being inserted into the second magnet insertion hole.

### TECHNICAL FIELD

The present invention relates to a rotor for a rotating electric machine in which permanent magnets are inserted into magnet insertion holes, and a method of manufacturing the same.

### BACKGROUND ART

Hitherto, there has been known a rotor for a rotating electric machine including a rotor core having a plurality of magnet insertion holes, and a plurality of permanent magnets inserted into the plurality of magnet insertion holes, respectively (for example, Patent Literature 1).

### CITATION LIST

### Patent Literature

[PTL 1] JP 2010-063283 A

### SUMMARY OF INVENTION

### Technical Problem

However, the permanent magnets are formed of sintered magnets. Thus, variations occur in dimensions of the plurality of permanent magnets in a thickness direction. Accordingly, dimensions of the magnet insertion holes become larger so that the plurality of permanent magnets can be inserted into the magnet insertion holes. Thus, gaps between wall surfaces of the magnet insertion holes and the permanent magnets become larger. As a result, there is a problem in that the efficiency of the rotating electric machine is lowered.

This invention has been made to solve the problem as described above, and has an object to provide a rotor for a rotating electric machine and a method of manufacturing the same, which can improve the efficiency of the rotating electric machine.

### Solution to Problem

A rotor for a rotating electric machine according to this invention includes: a rotor core having a plurality of magnet insertion holes formed so as to be arranged side by side in a circumferential direction of the rotor core; and a plurality of permanent magnets inserted into the plurality of magnet insertion holes, respectively, wherein the plurality of permanent magnets are classified into a first permanent magnet having a dimension in a thickness direction which is within a range of a set tolerance and smaller than a set value, and a second permanent magnet having a dimension in the thickness direction which is within the range of the set tolerance and larger than the set value, and wherein the plurality of magnet insertion holes are classified into a first magnet insertion hole into which the first permanent magnet is inserted, and a second magnet insertion hole which is formed to have a dimension in a width direction larger than a dimension of the first magnet insertion hole in the width direction and into which the second magnet insertion hole is inserted.

A method of manufacturing a rotor for a rotating electric machine according to this invention includes: a thickness dimension measuring step of measuring a dimension of each of a plurality of permanent magnets in a thickness direction; a permanent magnet sorting step of sorting, after the thickness dimension measuring step, the permanent magnet having the dimension in the thickness direction which is within a range of a set tolerance and smaller than a set value as a first permanent magnet, and the permanent magnet having the dimension in the thickness direction which is within the range of the set tolerance and larger than the set value as a second permanent magnet; and a permanent magnet inserting step of inserting, after the permanent magnet sorting step, the first permanent magnet into a first magnet insertion hole formed in a rotor core, and the second permanent magnet into a second magnet insertion hole formed in the rotor core and having a dimension in a width direction which is larger than a dimension of the first magnet insertion hole in the width direction.

### Advantageous Effects of Invention

According to the rotor for a rotating electric machine and a method of manufacturing the same of this invention, the efficiency of the rotating electric machine can be improved.

### BRIEF DESCRIPTION OF DRAWINGS

FIG. 1 is a sectional view for illustrating a rotor for a rotating electric machine according to a first embodiment of this invention.

FIG. 2 is a sectional view for illustrating a rotor for a rotating electric machine in a comparative example.

FIG. 3 is a graph for showing a frequency of dimensions of permanent magnets of FIG. 2 in a thickness direction.

FIG. 4 is a graph for showing a frequency of dimensions of permanent magnets of FIG. 1 in the thickness direction.

FIG. 5 is a diagram for illustrating a magnetic circuit for calculating an operating point of the permanent magnet.

FIG. 6 is a graph for showing the operating point of the permanent magnet.

FIG. 7 is a graph for showing the operating point of the permanent magnet when an average gap between a wall surface of a magnet insertion hole and the permanent magnet is reduced.

FIG. 8 is a flowchart for illustrating a method of manufacturing the rotor of FIG. 1.

FIG. 9 is a graph for showing a modification example of the frequency of the dimensions of the permanent magnets of FIG. 4 in the thickness direction.

FIG. 10 is a sectional view for illustrating a rotor for a rotating electric machine according to a second embodiment of this invention.

FIG. 11 is a graph for showing a frequency of dimensions of permanent magnets inserted into magnet insertion holes of FIG. 10 in the thickness direction.

FIG. 12 is a graph for showing operating points of the permanent magnets in the rotor for a rotating electric machine according to the second embodiment.

FIG. 13 is a view for illustrating a flow of a magnetic flux passing through the rotor of FIG. 10.

FIG. 14 is a graph for showing a modification example of the frequency of the dimensions of the permanent magnets of FIG. 11 in the thickness direction.

FIG. 15 is a graph for showing the operating points of the permanent magnets in the modification example of the rotor for a rotating electric machine according to the second embodiment.

FIG. 16 is a sectional view for illustrating a rotor for a rotating electric machine according to a third embodiment of this invention.

FIG. 17 is a graph for showing a frequency of dimensions of permanent magnets inserted into magnet insertion holes of FIG. 16 in the thickness direction.

FIG. 18 is a graph for showing operating points of the permanent magnets in the rotor for a rotating electric machine according to the third embodiment.

FIG. 19 is a graph for showing a modification example of the frequency of the dimensions of the permanent magnets of FIG. 17 in the thickness direction.

FIG. 20 is a graph for showing the operating points of the permanent magnets in the modification example of the rotor for a rotating electric machine according to the third embodiment.

FIG. 21 is a sectional view for illustrating a rotor for a rotating electric machine according to a fourth embodiment of this invention.

FIG. 22 is a sectional view for illustrating a modification example of permanent magnets of FIG. 1.

### DESCRIPTION OF EMBODIMENTS

### First Embodiment

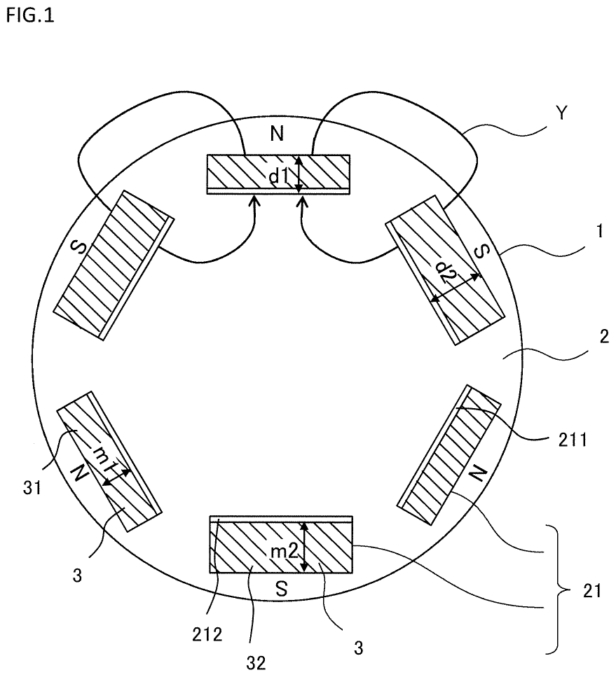

FIG. 1 is a sectional view for illustrating a rotor for a rotating electric machine according to a first embodiment of this invention. A rotor 1 for a rotating electric machine includes a rotor core 2 and a plurality of permanent magnets 3. The rotor core 2 has a columnar shape. The plurality of permanent magnets 3 are provided to the rotor core 2, and are each formed into a rectangular parallelepiped shape. The rotor core 2 has a plurality of magnet insertion holes 21 arranged side by side in a circumferential direction. In this example, the circumferential direction refers to a circumferential direction of the rotor core 2. The permanent magnets 3 are in surface contact with wall surfaces of the magnet insertion holes 21 which are arranged on a radially outer side. Gaps are defined between wall surfaces of the magnet insertion holes 21 which are arranged on a radially inner side and the permanent magnets 3. The gaps defined between the wall surfaces of the magnet insertion holes 21 and the permanent magnets 3 refer to the gaps defined between the wall surfaces of the magnet insertion holes which are arranged on the radially inner side and the permanent magnets 3.

The plurality of permanent magnets 3 are inserted into the magnet insertion holes 21, respectively. In this example, the number of poles of the rotor 1 is six. The number of poles of the rotor 1 is not limited thereto, and may be other numbers. Further, in this example, one permanent magnet 3 is arranged in one magnetic pole of the rotor 1. In other words, one permanent magnet 3 forms one magnetic pole of the rotor 1. A pair of permanent magnets 3 adjacent to each other in the circumferential direction are arranged such that magnetic poles at radially outer portions are different from each other. In other words, the magnetic poles of the radially outer portions of the plurality of permanent magnets 3 are arranged such that N poles and S poles are alternately arranged in the circumferential direction. In this example, the radial direction refers to a radial direction of the rotor core 2.

The plurality of permanent magnets 3 are classified into first permanent magnets 31 and second permanent magnets 32. A dimension of the first permanent magnet 31 in a thickness direction is smaller than a dimension of the second permanent magnet 32 in the thickness direction. In this example, the thickness direction matches the radial direction. The dimension of the first permanent magnet 31 in the thickness direction is ml. The dimension of the second permanent magnet 32 in the thickness direction is m2. In this case, a relationship of ml<m2 is satisfied. The plurality of permanent magnets 3 are arranged such that the first permanent magnets 31 and the second permanent magnets 32 are alternately arranged side by side in the circumferential direction.

The N poles are arranged at radially outer portions of the first permanent magnets 31, and the S poles are arranged at radially outer portions of the second permanent magnets 32. There is formed a flow Y of a magnetic flux passing from the N pole of the first permanent magnet 31 through the rotor core 2 and returning to the S pole of the second permanent magnet 32.

The plurality of magnet insertion holes 21 are classified into first magnet insertion holes 211 and second magnet insertion holes 212. A dimension of the first magnet insertion hole 211 in a width direction is smaller than a dimension of the second magnet insertion hole 212 in the width direction. The width direction in the magnet insertion hole 21 matches the thickness direction of the permanent magnet 3 inserted into the magnet insertion hole 21. The first permanent magnet 31 is inserted into the first magnet insertion hole 211. The second permanent magnet 32 is inserted into the second magnet insertion hole 212. A dimension of the first magnet insertion hole 211 in the width direction is dl. A dimension of the second magnet insertion hole 212 in the width direction is d2. In this case, a relationship of d1<d2 is satisfied. The plurality of magnet insertion holes 21 are arranged such that the first magnet insertion holes 211 and the second magnet insertion holes 212 are alternately arranged side by side in the circumferential direction.

Next, dimensions of the permanent magnets 3 in the thickness direction are described. As the permanent magnets 3, sintered magnets such as neodymium magnets, ferrite magnets, or samarium cobalt magnets are used. The permanent magnets 3 are manufactured by cutting a sintered body having a block shape into set dimensions. Manufacturing errors occur in the dimensions of the plurality of permanent magnets 3 in the thickness direction. A range of the errors in the dimensions of the permanent magnets 3 in the thickness direction is in a range of about ±0.1 mm with respect to a set value. The range of ±0.1 mm with respect to the set value is defined as a set tolerance of the dimensions of the permanent magnets 3 in the thickness direction. The set tolerance is not limited thereto, and may be other values. In this example, an average value of the dimensions of the plurality of permanent magnets 3 in the thickness direction is defined as the set value. The set value is not limited thereto, and may be other values.

In general, the magnet insertion holes 21 are formed by punching the rotor core 2 with use of an edged tool such as a die. Thus, manufacturing errors occur in the dimensions of the plurality of magnet insertion holes 21 in the width direction. A range of the errors in the dimensions of the magnet insertion holes 21 in the width direction is a range of from several pm to several tens pm with respect to a set value. The range of the errors in the dimensions of the permanent magnets 3 in the thickness direction is sufficiently larger than the range of the errors in the dimensions of the magnet insertion holes 21 in the width direction. Thus, in this example, description is made of a case in which errors do not occur in the dimensions of the magnet insertion holes 21 in the width direction, whereas errors occur in the dimensions of the permanent magnets 3 in the thickness direction.

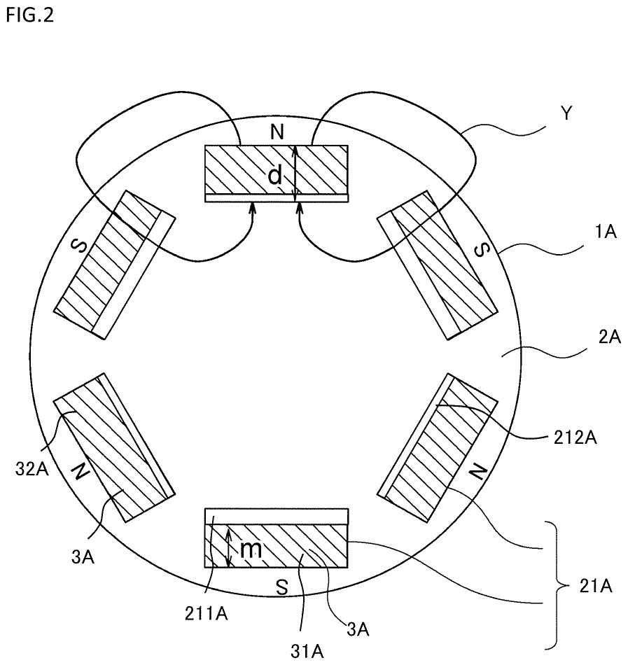

FIG. 2 is a sectional view for illustrating a rotor 1A of a rotating electric machine in a comparative example. Similarly to the rotor 1, the rotor 1A includes a rotor core 2A and a plurality of permanent magnets 3A. The plurality of permanent magnets 3A are provided to the rotor core 2A, and are each formed into a rectangular parallelepiped shape. The rotor core 2A has a plurality of magnet insertion holes 21A arranged side by side in the circumferential direction. The plurality of permanent magnets 3A are inserted into the magnet insertion holes 21A, respectively.

Dimensions of the plurality of magnet insertion holes 21A in the width direction are equal to each other. The plurality of magnet insertion holes 21A are each formed with a margin with respect to the set tolerance of the dimension of the permanent magnet 3 in the thickness direction so that the permanent magnets 3A can be inserted into the magnet insertion holes 21A even when errors occur in dimensions of the permanent magnets 3A in the thickness direction.

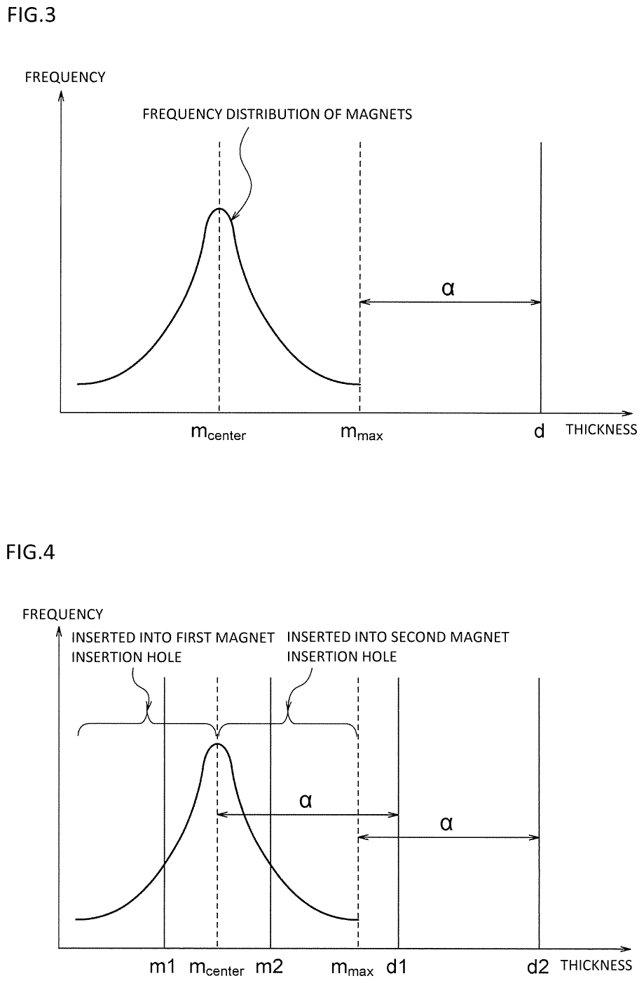

FIG. 3 is a graph for showing a frequency of the dimensions of the permanent magnets 3A of FIG. 2 in the thickness direction. In FIG. 3, the horizontal axis represents the dimension of the permanent magnet 3A in the thickness direction, and the vertical axis represents the frequency. In FIG. 3, the dimensions of the magnet insertion holes 21A in the width direction are also shown. In FIG. 3, a case in which the frequency of the dimensions of the permanent magnets 3A in the thickness direction conforms to a normal distribution is shown. An average value of the dimensions of the permanent magnets 3A in the thickness direction is m_{center}. The frequency at which the dimension of the permanent magnet 3A in the thickness direction is mcenter is the largest. The maximum value of the dimension of the permanent magnet 3A in the thickness direction is mₘₐₓ. The permanent magnets 3A can be inserted into the magnet insertion holes 21A even when variations occur in the dimensions of the permanent magnets 3A in the thickness direction. The dimension of the magnet insertion hole 21A in the width direction is “d”. “d” is larger than mₘₐₓ by a set dimension “α”. Thus, a relationship of d=mₘₐₓ+α is satisfied. A dimension of an average gap between the wall surface of the magnet insertion hole 21A and the permanent magnet 3A is d−M_{center}.

FIG. 4 is a graph for showing a frequency of the dimensions of the permanent magnets 3 of FIG. 1 in the thickness direction. In FIG. 4, the horizontal axis represents the dimension of the permanent magnet 3 in the thickness direction, and the vertical axis represents the frequency. In FIG. 4, the dimensions of the magnet insertion holes 21 in the width direction are also shown. In FIG. 4, a case in which the frequency of the dimensions of the permanent magnets 3 in the thickness direction conforms to a normal distribution is shown. An average value of the dimensions of the permanent magnets 3 in the thickness direction is M_{center}. The maximum value of the dimension of the permanent magnet 3 in the thickness direction iS mₘₐₓ.

The plurality of permanent magnets 3 are classified into permanent magnets 3 each having a dimension in the thickness direction which is smaller than mcenter, and permanent magnets 3 each having a dimension in the thickness direction which is larger than M_{center}. Of the plurality of permanent magnets 3, the permanent magnets 3 each having the dimension in the thickness direction which is smaller than mcenter are defined as the first permanent magnets 31, and the permanent magnets 3 each having the dimension in the thickness direction which is larger than mcenter are defined as the second permanent magnets 32. An average value of the dimensions of the first permanent magnets 31 in the thickness direction is m1, and an average value of the dimensions of the second permanent magnets 32 in the thickness direction is m2. In this case, a relationship of m1<M_{center}<m2 is satisfied.

The maximum value of the dimension of the first permanent magnet 31 in the thickness direction is M_{center}. Thus, when a relationship of d1=m_{center}+α is satisfied, the first permanent magnets 31 can be inserted into the first magnet insertion holes 211.

The maximum value of the dimension of the second permanent magnet 32 in the thickness direction is m.. Thus, when a relationship of d2=mₘₐₓ+α is satisfied, the second permanent magnets 32 can be inserted into the second magnet insertion holes 212.

Next, the dimensions of the gaps between the wall surfaces of the magnet insertion holes 21 and the permanent magnets 3 are described. A dimension of an average gap between the wall surface of the first magnet insertion hole 211 and the first permanent magnet 31 is d1-m1. A dimension of an average gap between the wall surface of the second magnet insertion hole 212 and the second permanent magnet 32 is d2-m2.

Meanwhile, the dimension of the average gap between the wall surface of the magnet insertion hole 21A and the permanent magnet 3A is d-m_{center}. Here, a relationship of m_{center}<m2 is given, and a relationship of d=d2 is given. Thus, a relationship of d2-m2<d-m_{center} is satisfied.

When the frequency of the dimensions of the permanent magnets 3 in the thickness direction conforms to the normal distribution, a frequency at which the dimension in the thickness direction is m_{center} in the plurality of permanent magnets 3 is larger than a frequency at which the dimension in the thickness direction is other dimensions. Thus, a relationship of m_{center}−m1<mₘₐₓ−m2 is satisfied. With this, a relationship of m_{center}−m1+α<mₘₐₓ−m2+α is satisfied. Further, a relationship of m_{center}+α=d1 is given, and a relationship of mₘₐₓ+α=d2 is given. Thus, a relationship of d1−m1<d2−m2 is satisfied. With this, a relationship of d1−m1<d2−m2<d−m_{center} is satisfied. In other words, the dimension of the average gap between the wall surface of the first magnet insertion hole 211 and the first permanent magnet 31 and the dimension of the average gap between the wall surface of the second magnet insertion hole 212 and the second permanent magnet 32 are smaller than the dimension of the average gap between the wall surface of the magnet insertion hole 21A and the permanent magnet 3A.

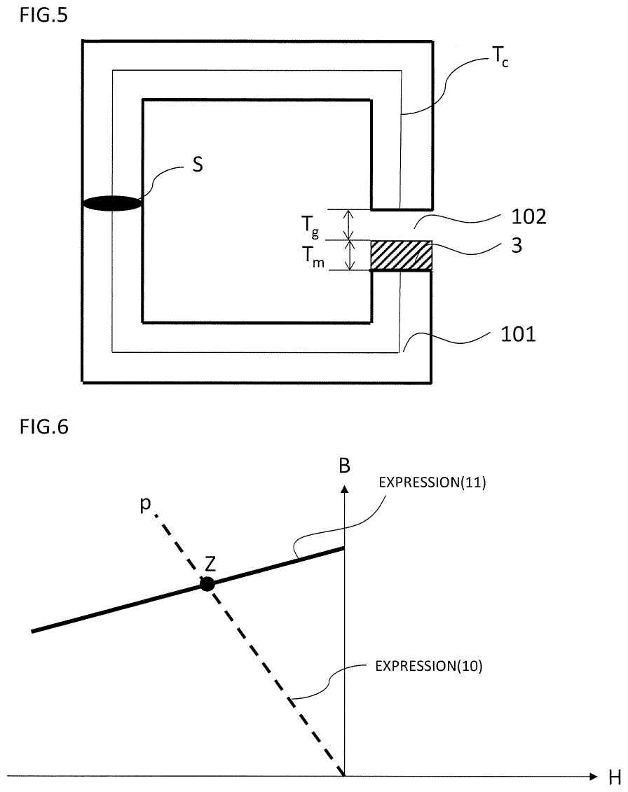

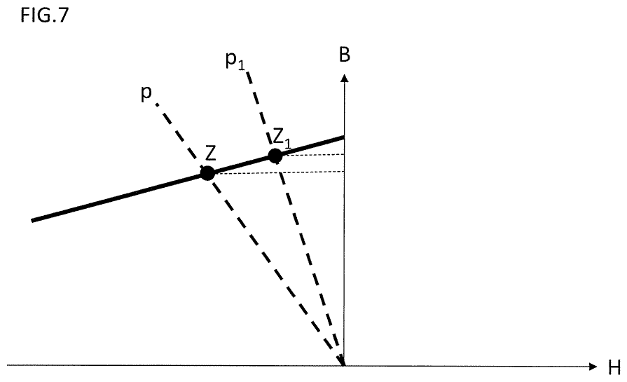

Next, an operating point of the permanent magnet 3 is described. FIG. 5 is a diagram for illustrating a magnetic circuit for calculating the operating point of the permanent magnet 3. FIG. 6 is a graph for showing the operating point of the permanent magnet 3. FIG. 7 is a graph for showing the operating point of the permanent magnet 3 when an average gap between a wall surface of a magnet insertion hole 21 and the permanent magnet 3 is reduced. In FIG. 5, the permanent magnet 3 is provided at one longitudinal end portion of a core portion 101 formed in a C-shape, and a gap portion 102 is defined between the other longitudinal end portion of the core portion 101 and the permanent magnet 3. A dimension of the permanent magnet 3 in the thickness direction is T., a dimension of the gap portion 102 is T_{g}, and a magnetic path length of the core portion 101 is T_{g}. A sectional area of the permanent magnet 3, a sectional area of the gap portion 102, and a sectional area of the core portion 101 are each S and are equal to each other. In this case, Expression (1) below is established based on by the Ampere's law.

Φ·d1=0 (1)

Thus, when a magnetic field of the permanent magnet 3 is Hₘ, a magnetic field of the gap portion 102 is H_{g}, and a magnetic field of the core portion 101 is H_{c}, Expression (2) below is derived.

Hₘ·Tₘ+H_{g}·T_{g}+H_{c}·T_{c}=0

Further, the magnetic flux is constant at any portion. Thus, when the sectional area S is constant, the magnetic flux density is also constant. Accordingly, when the magnetic flux density inside the permanent magnet 3 is Bₘ, the magnetic flux density of the gap portion 102 is B_{g}, and the magnetic flux density inside the core portion 101 is B_{c}, the respective values are equal to each other. Meanwhile, the relationships between the magnetic fields and the magnetic flux densities satisfy Expression (3), Expression (4), and Expression (5) below.

Bₘ=μ₀μᵣₘHₘ (3)

B_{g}=μ₀H_{g} (4)

B_{c}=μ₀μ_{rc}H_{c} (5)

The symbol μ₀ represents the magnetic permeability of the vacuum, the symbol prm represents the relative permeability of the permanent magnet 3, and the symbol μ_{rc} represents the relative permeability of iron. When the permanent magnet 3 is a neodymium magnet, the symbol μᵣₘ is about 1.05. Based on Expression (3), Expression (4), and Expression (5) above, the magnetic field H_{g} of the gap portion 102 and the magnetic field H_{c} of the core portion 101 satisfy Expression (6) and Expression (7) below.

H_{g}=Bₘ/μ₀ (6)

H_{c}=Bₘ/(μ₀μ_{rc}) (7)

Expression (6) and Expression (7) above are substituted into Expression (2) above so that Expression (8) below is derived.

Hₘ·Tₘ+Bₘ/μ₀·T_{g}+Bₘ/(μ₀μ_{rc})·T_{c}=0 (8)

Here, when the magnetic flux of the core portion 101 is not saturated, the symbol μ₀ is 1,000 or more. In this case, in Expression (8) above, the value indicated by the third term is sufficiently smaller than the value indicated by the first term and the value indicated by the second term. Thus, in this case, Expression (8) above can be represented by Expression (9) below.

Hₘ·Tₘ+Bₘ/μ₀·T_{g}=0 (9)

Expression (10) below is derived from Expression (9) above.

p=Bₘ/Hₘ=−μ₀·Tₘ/T_{g} (10)

Here, the symbol “p” corresponds to a value called a permeance coefficient. The magnetic flux density of the permanent magnet 3 can be expressed by Expression (11) below.

Bₘ=μ₀μᵣₘHₘ+M (11)

The relationship between the magnetic flux density and the magnetic field of the permanent magnet 3 is as shown in FIG. 6. Expression (10) above is shown in FIG. 6 as a straight line represented by an inclination −p in the second quadrant. In this case, the operating point of the permanent magnet 3 is a point Z that satisfies both Expression (10) above and Expression (11) above.

In the first embodiment, the gap portion 102 is smaller than that in the comparative example. Thus, in Expression (10) above, T_{g} becomes smaller. With this, the permeance coefficient “p” becomes larger. The permeance coefficient in this case is p₁. As shown in FIG. 7, when the permeance coefficient is p₁, the operating point of the permanent magnet 3 is Z₁ at an intersection point which has a magnetic flux density larger than that of the point Z. Although the improvement in the operating point of the permanent magnet 3 when the average gap is reduced is described by using the magnetic circuit having a C-shape in FIG. 4, also in a rotating electric machine, the operating point of the permanent magnet 3 can be improved by the same principle.

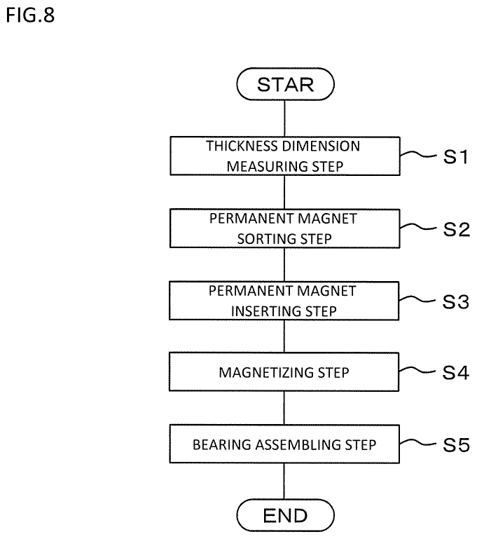

Next, a method of manufacturing the rotor 1 for a rotating electric machine is described. FIG. 8 is a flowchart for illustrating the method of manufacturing the rotor 1 of FIG. 1. First, in Step S1, a thickness dimension measuring step is performed. In the thickness dimension measuring step, dimensions of the plurality of permanent magnets 3 in the thickness direction are measured. Further, in the thickness dimension measuring step, an average value of the dimensions of the plurality of permanent magnets 3 in the thickness direction is calculated.

After that, in Step S2, a permanent magnet sorting step is performed. In the permanent magnet sorting step, the permanent magnets 3 each having the dimension in the thickness direction which is within the range of the set tolerance and smaller than the set value are sorted as the first permanent magnets 31. Further, in the permanent magnet sorting step, the permanent magnets 3 each having the dimension in the thickness direction which is within the range of the set tolerance and larger than the set value are sorted as the second permanent magnets 32. In the permanent magnet sorting step, the average value is set as the set value.

After that, in Step S3, a permanent magnet inserting step is performed. In the permanent magnet inserting step, the first permanent magnets 31 are inserted into the first magnet insertion holes 211, and the second permanent magnets 32 are inserted into the second magnet insertion holes 212.

After that, in Step S4, a magnetizing step is performed. In the magnetizing step, the first permanent magnets 31 and the second permanent magnets 32 are magnetized.

After that, in Step S5, a bearing assembling step is performed. In the bearing assembling step, a bearing (not shown) is mounted to a shaft (not shown) of the rotor 1. Accordingly, the manufacture of the rotor 1 for a rotating electric machine is completed.

As described above, with the rotor 1 for a rotating electric machine according to the first embodiment of this invention, the plurality of permanent magnets 3 are classified into the first permanent magnets 31 and the second permanent magnets 32. The plurality of magnet insertion holes 21 are classified into the first magnet insertion holes 211 and the second magnet insertion holes 212. The first permanent magnets 31 are inserted into the first magnet insertion holes 211, and the second permanent magnets 32 are inserted into the second magnet insertion holes 212. With this, the dimension of the average gap between the wall surface of the first magnet insertion hole 211 and the first permanent magnet 31 and the dimension of the average gap between the wall surface of the second magnet insertion hole 212 and the second permanent magnet 32 can be reduced. Thus, the operating point of the permanent magnet 3 can be improved. As a result, the efficiency of the rotating electric machine can be improved.

Further, the first permanent magnets 31 and the second permanent magnets 32 form magnetic poles different from each other in the rotor 1. With this, the balance of the weight in the circumferential direction in the rotor 1 can be improved. Thus, the magnetic characteristic of each pole pair in the rotor 1 is stabilized. As a result, generation of sound and vibration in the rotating electric machine can be suppressed.

Further, with the method of manufacturing the rotor for a rotating electric machine according to the first embodiment of this invention, the first permanent magnets 31 are inserted into the first magnet insertion holes 211, and the second permanent magnets 32 are inserted into the second magnet insertion holes 212. With this, the dimension of the average gap between the wall surface of the first magnet insertion hole 211 and the first permanent magnet 31 and the dimension of the average gap between the wall surface of the second magnet insertion hole 212 and the second permanent magnet 32 can be reduced. Thus, the operating point of the permanent magnet 3 can be improved. As a result, the efficiency of the rotating electric machine can be improved.

Further, the average value of the dimensions of the permanent magnets 3 in the thickness direction is used as the set value of the dimension of the permanent magnet 3 in the thickness direction. With this, the plurality of permanent magnets 3 can be evenly classified into the first permanent magnets 31 and the second permanent magnets 32.

In the above-mentioned first embodiment, description has been made of the configuration in which the N poles are arranged at the radially outer portions of the first permanent magnets 31, and the S poles are arranged at the radially outer portions of the second permanent magnets 32. However, there may be employed a configuration in which the S poles are arranged at the radially outer portions of the first permanent magnets 31, and the N poles are arranged at the radially outer portions of the second permanent magnets 32. Even in this case, there is formed a flow Y of the magnetic flux passing from the N pole of the second permanent magnet 32 through the rotor core and returning to the S pole of the first permanent magnet 31.

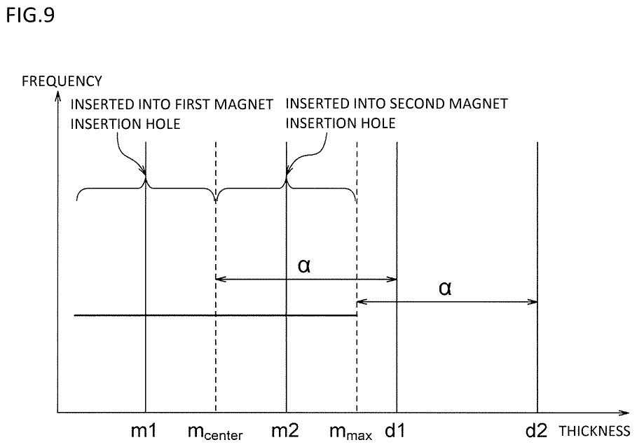

Further, in the above-mentioned first embodiment, description has been made of the case in which the frequency of the dimensions of the permanent magnets 3 in the thickness direction conforms to the normal distribution. However, as shown in FIG. 9, the frequency of the dimensions of the permanent magnets 3 in the thickness direction may be constant. In this case, a relationship of d1−m1=d2−m2<d-m_{center} is satisfied. Thus, the dimension of the average gap between the wall surface of the first magnet insertion hole 211 and the first permanent magnet 31 and the dimension of the average gap between the wall surface of the second magnet insertion hole 212 and the second permanent magnet 32 are smaller than the dimension of the average gap between the wall surface of the magnet insertion hole 21A and the permanent magnet 3A.

Further, description has been made of the method of manufacturing the rotor 1 for a rotating electric machine, in which the magnetizing step is performed after the permanent magnet inserting step. However, there may be employed a method of manufacturing the rotor 1 for a rotating electric machine, in which the magnetizing step is performed before the permanent magnet inserting step.

### Second Embodiment

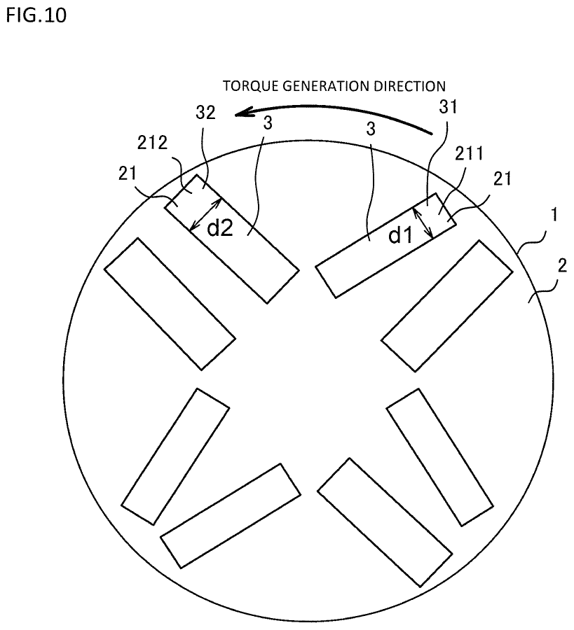

FIG. 10 is a sectional view for illustrating a rotor for a rotating electric machine according to a second embodiment of this invention. In this example, the number of poles of the rotor 1 is four. A pair of permanent magnets 3 form one magnetic pole of the rotor 1. The pair of permanent magnets 3 forming one magnetic pole of the rotor 1 are arranged in a V shape. The pair of permanent magnets 3 are arranged so as to be away from each other toward the radially outer side. Similarly to the first embodiment, the pair of permanent magnets 3 are classified into the first permanent magnet 31 and the second permanent magnet 32.

The rotor core 2 has pairs of magnet insertion holes 21 into which the pairs of permanent magnets 3 are inserted. Similarly to the first embodiment, the pair of magnet insertion holes 21 are classified into the first magnet insertion hole 211 and the second magnet insertion hole 212. In the pair of magnet insertion holes 21, the magnet insertion hole 21 arranged on a delay side in a torque generation direction of the rotor 1 corresponds to the first magnet insertion hole 211, and the magnet insertion hole 21 arranged on an advance side in the torque generation direction corresponds to the second magnet insertion hole 212.

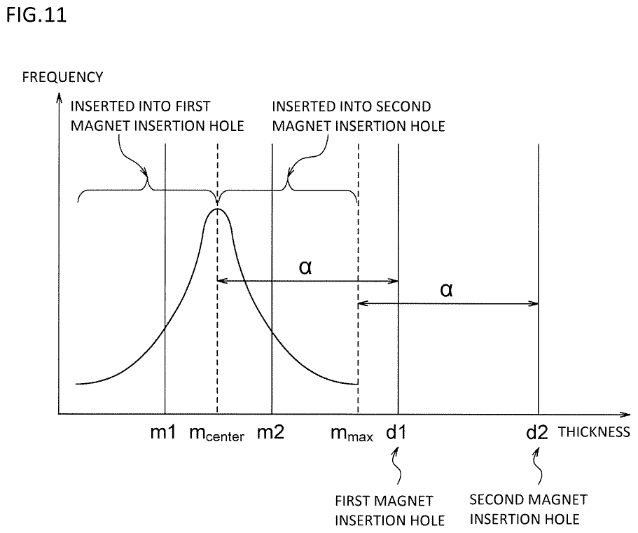

FIG. 11 is a graph for showing a frequency of dimensions of the permanent magnets 3 in the thickness direction, which are inserted into the magnet insertion holes 21 of FIG. 10. In FIG. 11, the horizontal axis represents the dimension of the permanent magnet 3 in the thickness direction, and the vertical axis represents the frequency. In FIG. 11, the dimensions of the magnet insertion holes 21 in the width direction are also shown. In FIG. 11, there is shown a case in which the frequency of the dimensions of the permanent magnets 3 in the thickness direction conforms to the normal distribution.

A set value of the dimension of the permanent magnet 3 in the thickness direction is 5 mm. A set tolerance of the dimension of the permanent magnet 3 in the thickness direction is ±0.1 mm. The dimension of the magnet insertion hole 21 in the width direction is a value obtained by adding 0.1 mm to the maximum value of the permanent magnet 3. As the permanent magnets 3, typical neodymium sintered magnets are used. The residual magnetic flux density is 1.3 T. The relative permeability is 1.05. A gap between the rotor 1 and a stator is 1 mm.

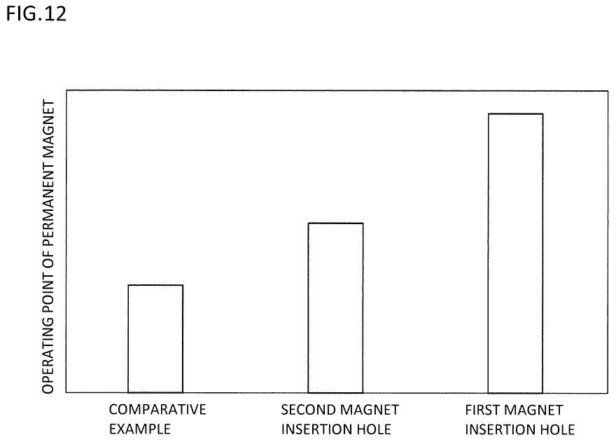

FIG. 12 is a graph for showing operating points of the permanent magnets 3 in the rotor 1 for a rotating electric machine according to the second embodiment. In FIG. 12, there is no magnetic flux leaking from the permanent magnets 3 to the inside of the rotor 1, and further, magnetic saturation does not occur in the rotor core 2. Further, in FIG. 12, an operating point of the permanent magnet 3 in a comparative example is also shown. As shown in FIG. 12, an operating point of the first permanent magnet 31 inserted into the first magnet insertion hole 211 is higher than an operating point of the second permanent magnet 32 inserted into the second magnet insertion hole 212. This is because the gap dimension between the wall surface of the first magnet insertion hole 211 and the first permanent magnet 31 is smaller than the gap dimension between the wall surface of the second magnet insertion hole 212 and the second permanent magnet 32. Further, as shown in FIG. 12, the operating point of the second permanent magnet 32 inserted into the second magnet insertion hole 212 is higher than an operating point of the permanent magnet inserted into the magnet insertion hole in the case of the comparative example.

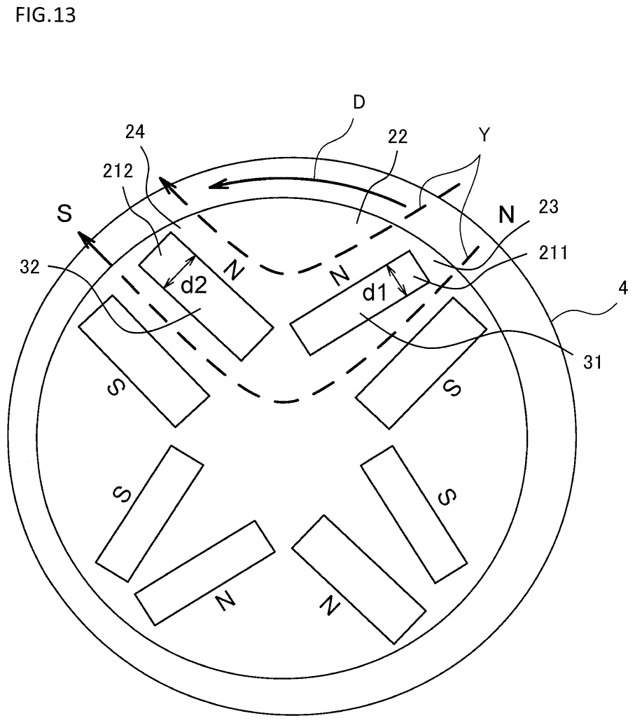

FIG. 13 is a view for illustrating a flow Y of the magnetic flux passing through the rotor 1 of FIG. 10. In FIG. 13, a stator 4 surrounding the rotor 1 is also illustrated. In order to cause torque to be generated in the rotor 1, magnetic poles of the stator 4 are required to be shifted with respect to the magnetic poles of the rotor 1 in a torque generation direction D. In other words, it is required to arrange the magnetic poles of the stator 4 so as to correspond to the magnetic poles of the rotor 1 so that the S poles of the rotor 1 and N poles of the stator 4 are attracted to each other, and the N poles of the rotor 1 and S poles of the stator 4 are attracted to each other. As illustrated in FIG. 13, the magnetic poles of the stator 4 are shifted with respect to the magnetic poles of the rotor 1 by 90° in the torque generation direction D. With this, in FIG. 13, torque is generated counterclockwise in the rotor 1. A case in which torque is generated in the rotor 1 in the same direction as the rotating direction of the rotor 1 corresponds to a power running operation, and a case in which torque is generated in the rotor 1 in a direction opposite to the rotating direction of the rotor 1 corresponds to a regenerative operation.

A portion of the rotor core 2 in which two permanent magnets 3 are arranged is referred to as a same-magnetic-pole forming portion 22. A portion of the same-magnetic-pole forming portion 22 on the delay side in the torque generation direction D is referred to as a same-magnetic-pole delay side portion 23. A portion of the same-magnetic-pole forming portion 22 on the advance side in the torque generation direction D is referred to as a same-magnetic-pole advance side portion 24. A magnetic flux passing between the stator 4 and the rotor 1 flows from the N pole to the S pole. Thus, in the same-magnetic-pole delay side portion 23, a flow of the magnetic flux entering the rotor from the stator 4 is formed, and in the same-magnetic-pole advance side portion 24, a flow of the magnetic flux flowing out from the rotor 1 to the stator 4 is formed.

In the same-magnetic-pole delay side portion 23, the magnetic flux generated by the permanent magnet 3 and the magnetic flux entering the rotor 1 from the stator 4 flow in directions of canceling out each other. Meanwhile, in the same-magnetic-pole advance side portion 24, the magnetic flux generated by the permanent magnet 3 and the magnetic flux flowing out from the rotor 1 to the stator 4 flow in the same direction. Thus, the permanent magnet 3 arranged in the same-magnetic-pole delay side portion 23 is easily demagnetized as compared to the permanent magnet 3 arranged in the same-magnetic-pole advance side portion 24.

The first permanent magnet 31 having a high operating point is arranged on the delay side in the torque generation direction D, and the second permanent magnet 32 having a low operating point is arranged on the advance side in the torque generation direction D. With this, the demagnetization resistance of the permanent magnets 3 is improved. Other configurations are the same as those of the first embodiment.

As described above, with the rotor 1 for a rotating electric machine according to the second embodiment of this invention, the first permanent magnet 31 and the second permanent magnet 32 form the same magnetic pole in the rotor 1. With this, the balance of the weight for each magnetic pole can be improved. With this, the magnetic characteristic of the rotor 1 is stabilized. As a result, generation of sound and vibration in the rotating electric machine can be suppressed.

Further, the first permanent magnet 31 and the second permanent magnet 32 are arranged such that the operating point of the permanent magnet 3 arranged on the delay side in the torque generation direction D is higher than the operating point of the permanent magnet 3 arranged on the advance side in the torque generation direction D. With this, the demagnetization resistance of the permanent magnets 3 can be improved. As a result, the efficiency of the rotating electric machine can be improved.

In the above-mentioned second embodiment, description has been made of the configuration in which the first permanent magnet 31 is arranged on the delay side with respect to the second permanent magnet 32 in the torque generation direction D. However, when the torque generation direction D is reversed, the first permanent magnet 31 may be arranged on the advance side with respect to the second permanent magnet 32 in the torque generation direction D.

Further, in the above-mentioned second embodiment, description has been made of the configuration in which the first permanent magnet 31 and the second permanent magnet 32 are arranged in one magnetic pole. However, there may be employed a configuration in which one of the first permanent magnet 31 and the second permanent magnet 32 is arranged in one magnetic pole, and the other of the first permanent magnet 31 and the second permanent magnet 32 is arranged in one magnetic pole adjacent to the above-mentioned magnetic pole.

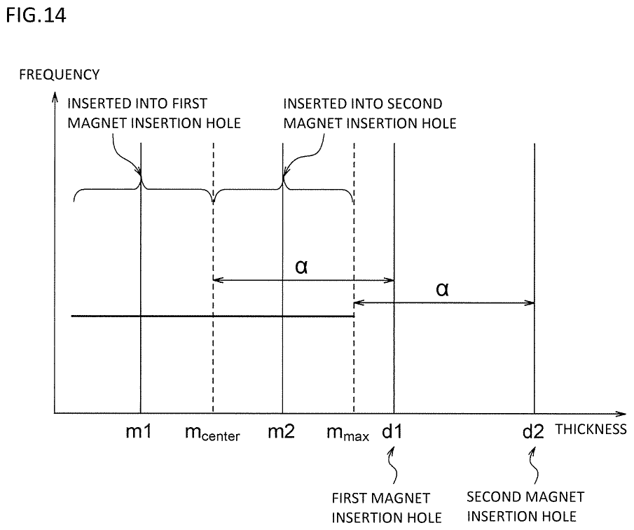

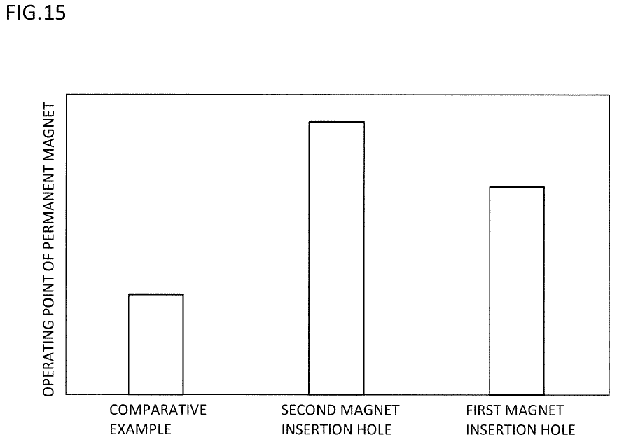

Further, in the above-mentioned second embodiment, description has been made of the case in which the frequency of the dimensions of the permanent magnets 3 in the thickness direction conforms to the normal distribution. However, as illustrated in FIG. 14, the frequency of the dimensions of the permanent magnets 3 in the thickness direction may be constant. In this case, the average gap between the wall surface of the magnet insertion hole 21 and the permanent magnet 3 is constant. In this case, as illustrated in FIG. 15, the operating point of the second permanent magnet 32 inserted into the second magnet insertion hole 212 is higher than the operating point of the first permanent magnet 31 inserted into the first magnet insertion hole 211. Thus, the second permanent magnet 32 is arranged on the delay side with respect to the first permanent magnet 31 in the torque generation direction D of the rotor 1. With this, the permanent magnets 3 are arranged such that the operating point of the permanent magnet 3 arranged on the delay side in the torque generation direction D is higher than the operating point of the permanent magnet 3 arranged on the advance side in the torque generation direction D. Thus, the demagnetization resistance of the permanent magnets 3 can be improved. As a result, the efficiency of the rotating electric machine can be improved.

### Third Embodiment

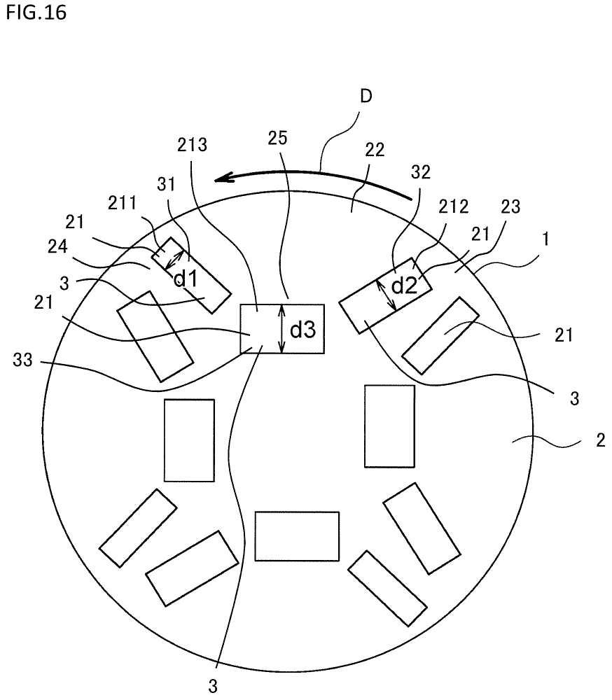

FIG. 16 is a sectional view for illustrating a rotor for a rotating electric machine according to a third embodiment of this invention. In this example, three permanent magnets 3 form one magnetic pole of the rotor 1. In other words, three permanent magnets 3 are used for one magnetic pole of the rotor 1. The three permanent magnets 3 are arranged side by side in a U shape. In other words, the three permanent magnets 3 are arranged side by side in a bathtub shape. In the three permanent magnets 3, the permanent magnet 3 arranged on the most advance side in the torque generation direction D is regarded as the first permanent magnet 31, the permanent magnet 3 arranged on the most delay side in the torque generation direction D is regarded as the second permanent magnet 32, and the remaining one permanent magnet 3 is regarded as a third permanent magnet 33.

The rotor core 2 has the first magnet insertion holes 211 into which the first permanent magnets 31 are inserted, the second magnet insertion holes 212 into which the second permanent magnets 32 are inserted, and third magnet insertion holes 213 into which the third permanent magnets 33 are inserted. The first magnet insertion hole 211, the second magnet insertion hole 212, and the third magnet insertion hole 213 are arranged side by side in a U shape.

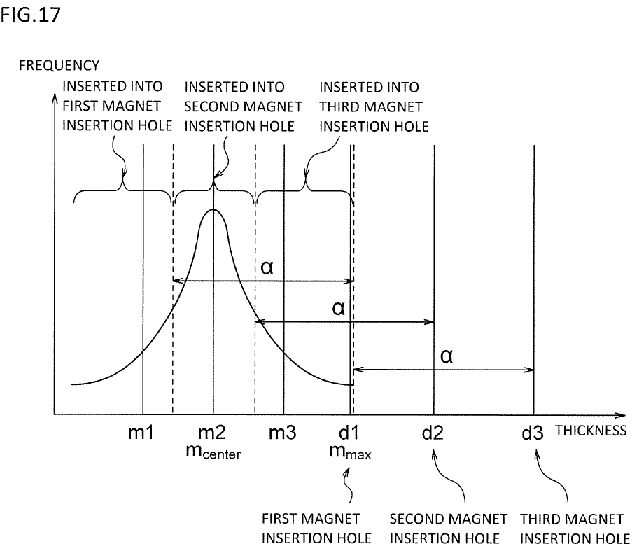

FIG. 17 is a graph for showing a frequency of dimensions of the permanent magnets 3 in the thickness direction, which are inserted into the magnet insertion holes 21 of FIG. 16. In FIG. 17, the horizontal axis represents the dimension of the permanent magnet 3 in the thickness direction, and the vertical axis represents the frequency. In FIG. 17, the dimensions of the magnet insertion holes 21 in the width direction are also shown. In FIG. 17, there is shown a case in which the frequency of the dimensions of the permanent magnets 3 in the thickness direction conforms to the normal distribution. The average value of the dimensions of the first permanent magnets 31 in the thickness direction is ml. The average value of the dimensions of the second permanent magnets 32 in the thickness direction is m2. An average value of dimensions of the third permanent magnets 33 in the thickness direction is m3. In this case, a relationship of m1<m2<m3 is satisfied. Further, a relationship of m2=m_{center} is given.

The dimension of the first magnet insertion hole 211 in the width direction is dl. The dimension of the second magnet insertion hole 212 in the width direction is d2. A dimension of the third magnet insertion hole 213 in the width direction is d3. In this case, a relationship of d1<d2<d3 is satisfied. The dimension dl is a value obtained by adding “a” to the maximum value of the dimension of the first permanent magnet 31 in the thickness direction. The dimension d2 is a value obtained by adding “a” to the maximum value of the dimension of the second permanent magnet 32 in the thickness direction. The dimension d3 is a value obtained by adding “a” to the maximum value of the dimension of the third permanent magnet 33 in the thickness direction.

The set value of the dimension of the permanent magnet 3 in the thickness direction is 5 mm. The set tolerance of the dimension of the permanent magnet 3 in the thickness direction is ±0.1 mm. The dimension of the magnet insertion hole 21 in the width direction is a value obtained by adding 0.1 mm to the maximum value of the permanent magnet 3. As the permanent magnets 3, typical neodymium sintered magnets are used. The residual magnetic flux density is 1.3 T. The relative permeability is 1.05. The gap between the rotor 1 and the stator is 1 mm.

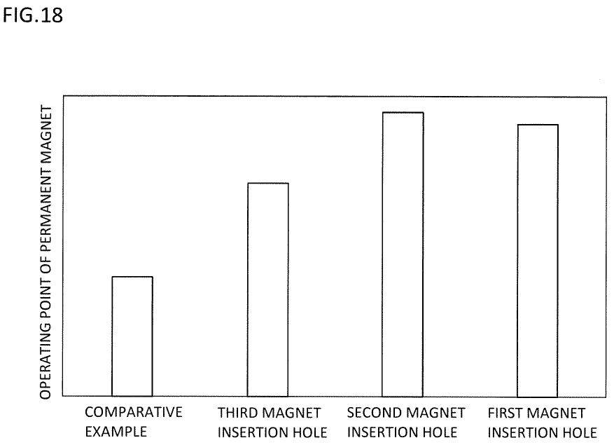

FIG. 18 is a graph for showing operating points of the permanent magnets 3 in the rotor for a rotating electric machine according to the third embodiment. In FIG. 18, there is no magnetic flux leaking from the permanent magnets 3 to the inside of the rotor 1, and further, magnetic saturation does not occur in the rotor core 2. Further, in FIG. 18, an operating point of the permanent magnet in a comparative example is also shown. As shown in FIG. 18, the operating point of the second permanent magnet 32 inserted into the second magnet insertion hole 212 is higher than the operating point of the first permanent magnet 31 inserted into the first magnet insertion hole 211. Further, the operating point of the first permanent magnet 31 inserted into the first magnet insertion hole 211 is higher than an operating point of the third permanent magnet 33 inserted into the third magnet insertion hole 213. In other words, the operating points become lower in the order of the operating point of the second permanent magnet 32 inserted into the second magnet insertion hole 212, the operating point of the first permanent magnet 31 inserted into the first magnet insertion hole 211, and the operating point of the third permanent magnet 33 inserted into the third magnet insertion hole 213. Further, the operating point of the third permanent magnet 33 inserted into the third magnet insertion hole 213 is higher than the operating point of the permanent magnet inserted into the magnet insertion hole in the case of the comparative example.

As illustrated in FIG. 16, a portion of the rotor core 2 in which the three permanent magnets 3 are arranged is referred to as the same-magnetic-pole forming portion 22. A portion of the same-magnetic-pole forming portion 22 on the delay side in the torque generation direction D is referred to as the same-magnetic-pole delay side portion 23. In the same-magnetic-pole forming portion 22, the same-magnetic-pole delay side portion 23 is most easily demagnetized. The second permanent magnet 32 is arranged in the same-magnetic-pole delay side portion 23.

A portion of the same-magnetic-pole forming portion 22 on the advance side in the torque generation direction D is referred to as the same-magnetic-pole advance side portion 24.

In the same-magnetic-pole forming portion 22, the same-magnetic-pole advance side portion 24 is easily demagnetized in the second place compared to the same-magnetic-pole delay side portion 23. In accordance with whether or not teeth of the stator 4 are adjacent to the same-magnetic-pole delay side portion 23, magnetic flux variations of high-order components are generated in the same-magnetic-pole delay side portion 23. With this, a change in magnetic flux occurs in the same-magnetic-pole delay side portion 23. The first permanent magnet 31 is arranged in the same-magnetic-pole advance side portion 24.

A portion of the same-magnetic-pole forming portion 22 on the radially inner side is referred to as a same-magnetic-pole radially inner portion 25. The same-magnetic-pole radially inner portion 25 is arranged away from the stator 4 than the same-magnetic-pole delay side portion 23 and the same-magnetic-pole advance side portion 24. Thus, the teeth of the stator 4 are not adjacent to the same-magnetic-pole radially inner portion 25. Accordingly, the same-magnetic-pole radially inner portion 25 is most difficult to be demagnetized in the same-magnetic-pole forming portion 22. The third permanent magnet 33 is arranged in the same-magnetic-pole radially inner portion 25. Other configurations are the same as those of the second embodiment.

As described above, with the rotor 1 for a rotating electric machine according to the third embodiment of this invention, the first permanent magnet 31, the second permanent magnet 32, and the third permanent magnet 33 form the same magnetic pole in the rotor 1. With this, the balance of the weight for each magnetic pole can be improved. With this, the magnetic characteristic of the rotor 1 is stabilized. As a result, generation of sound and vibration in the rotating electric machine can be suppressed.

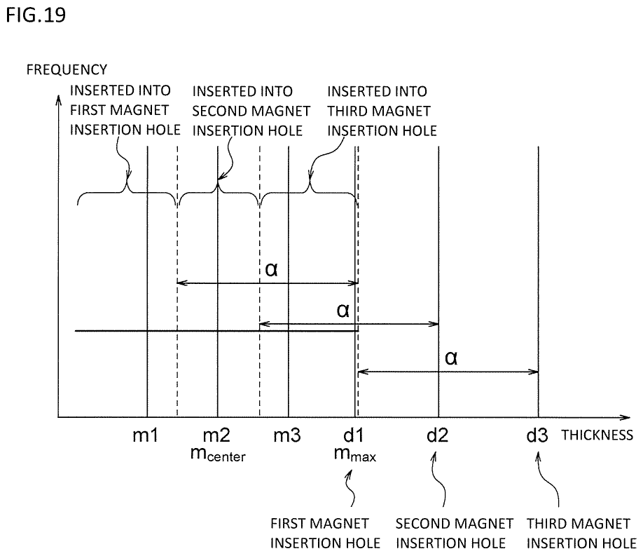

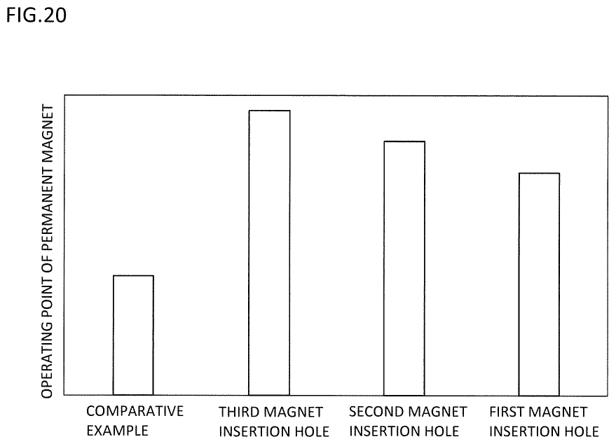

Further, in the above-mentioned third embodiment, description has been made of the case in which the frequency of the dimensions of the permanent magnets 3 in the thickness direction conforms to the normal distribution. However, as illustrated in FIG. 19, the frequency of the dimensions of the permanent magnets 3 in the thickness direction may be constant. In this case, the average gap between the wall surface of the magnet insertion hole 21 and the permanent magnet 3 is constant. In this case, as illustrated in FIG. 20, the operating point of the second permanent magnet 32 inserted into the second magnet insertion hole 212 is higher than the operating point of the first permanent magnet 31 inserted into the first magnet insertion hole 211. The operating point of the third permanent magnet 33 inserted into the third magnet insertion hole 213 is higher than the operating point of the second permanent magnet 32 inserted into the second magnet insertion hole 212. In other words, the operating points become lower in the order of the operating point of the third permanent magnet 33 inserted into the third magnet insertion hole 213, the operating point of the second permanent magnet 32 inserted into the second magnet insertion hole 212, and the operating point of the first permanent magnet 31 inserted into the first magnet insertion hole 211. Thus, the third permanent magnet 33 is arranged in the same-magnetic-pole delay side portion 23, the second permanent magnet 32 is arranged in the same-magnetic-pole advance side portion 24, and the first permanent magnet 31 is arranged in the same-magnetic-pole radially inner portion 25.

### Fourth Embodiment

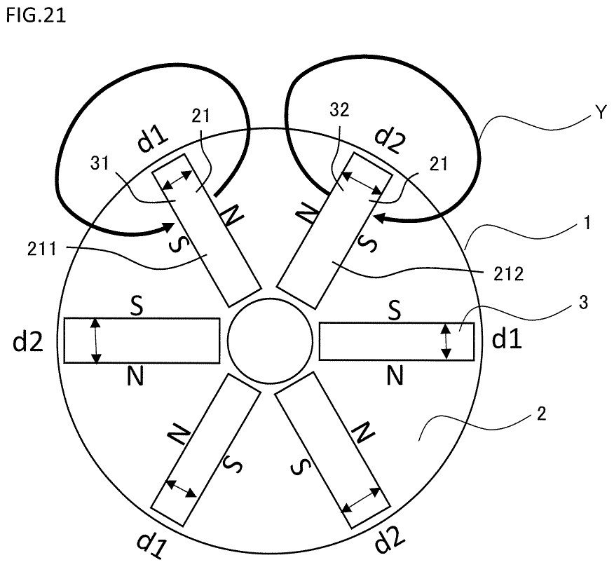

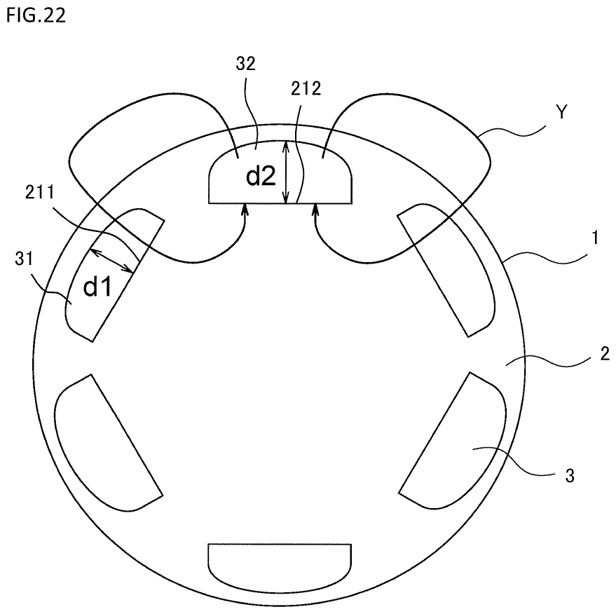

FIG. 21 is a sectional view for illustrating a rotor for a rotating electric machine according to a fourth embodiment of this invention. In this example, six permanent magnets 3 are provided to the rotor core 2. Each of the permanent magnets 3 is magnetized in the circumferential direction of the rotor core 2. On the surface of the rotor core 2, N poles and S poles are formed by flows Y of magnetic fluxes formed by the permanent magnets 3. Gaps are defined between the permanent magnets 3 and the rotor core 2 as described in the first embodiment, but in FIG. 21, those gaps are omitted.

In this configuration, the thickness direction of the permanent magnet 3 in the fourth embodiment corresponds to, as illustrated in FIG. 21, the circumferential direction of the rotor core 2. In other words, the dimension dl of the first permanent magnet 31 corresponds to a dimension of the first permanent magnet 31 in the circumferential direction, and the dimension d2 of the second permanent magnet 32 corresponds to a dimension of the second permanent magnet 32 in the circumferential direction. Thus, the thickness direction of the permanent magnet 3 is the same direction as the direction of the flow Y of the magnetic flux in the permanent magnet 3. Similarly to the first embodiment, the first magnet insertion holes 211 and the second magnet insertion holes 212 are alternately arranged one by one in the circumferential direction, the first permanent magnets 31 are arranged in the first magnet insertion holes 211, and the second permanent magnets 32 are arranged in the second magnet insertion holes 212. Other configurations are the same as those of the first to third embodiments.

As described above, with the rotor 1 for a rotating electric machine according to the fourth embodiment, similarly to the first embodiment, the gaps each defined between the permanent magnet 3 and the magnet insertion hole 21 can be reduced. With this, the operating point of the permanent magnet 3 can be improved, and torque of the rotating electric machine can be improved.

In the above-mentioned first to third embodiments, description has been made of the configuration in which the permanent magnets 3 each have a rectangular parallelepiped shape. However, for example, as illustrated in FIG. 22, the permanent magnets 3 may each have such a shape that a radially outer surface thereof is curved. In other words, the permanent magnets may each have a semi-circular shape. In this case, the dimension of the permanent magnet 3 in the thickness direction is a dimension of a maximum thickness portion of the permanent magnet 3.

### Reference Signs List

1, 1A rotor, 2, 2A rotor core, 3, 3A permanent magnet, 4 stator, 21, 21A magnet insertion hole, 22 same-magnetic-pole forming portion, 23 same-magnetic-pole delay side portion, 24 same-magnetic-pole advance side portion, 25 same-magnetic-pole radially inner portion, 31 first permanent magnet, 32 second permanent magnet, 101 core portion, 102 gap portion, 211 first magnet insertion hole, 212 second magnet insertion hole, 213 third magnet insertion hole

1. A rotor for a rotating electric machine, comprising:
a rotor core having a plurality of magnet insertion holes formed so as to be arranged side by side in a circumferential direction of the rotor core; and
a plurality of permanent magnets inserted into the plurality of magnet insertion holes, respectively,
wherein the plurality of permanent magnets include a first permanent magnet having a dimension in a thickness direction which is within a range of a set tolerance from a designed dimension and smaller than a set value, and a second permanent magnet having a dimension in the thickness direction which is within the range of the set tolerance from the designed dimension and larger than the set value, and
wherein the plurality of magnet insertion holes include a first magnet insertion hole into which the first permanent magnet is inserted, and a second magnet insertion hole which has a dimension in a width direction larger than a dimension of the first magnet insertion hole in the width direction and into which the second permanent magnet is inserted.

2.-6. (canceled)

7. A rotor for a rotating electric machine, in which a core formed by arranging a plurality of permanent magnets in a circumferential direction of the core is configured to rotate, the rotor for a rotating electric machine comprising:
a first permanent magnet included in the plurality of permanent magnets;
a second permanent magnet included in the plurality of permanent magnets and having a thickness in a radial direction which is larger than a thickness of the first permanent magnet in the radial direction; and
a first magnet insertion hole into which the first permanent magnet is inserted, the first magnet insertion hole having a width dimension in the radial direction which is larger than the thickness of the first permanent magnet; and
a second magnet insertion hole into which the second permanent magnet is inserted, the second magnet insertion hole having a width dimension in the radial direction which is larger than the thickness of the second permanent magnet,
wherein a difference between the width dimension of the first magnet insertion hole and an average value of thickness of the first permanent magnet is smaller than a difference between the width dimension of the second magnet insertion hole and an average value of the thickness of the second permanent magnet.

8. The rotor for a rotating electric machine according to claim 7,
wherein the thickness of the first permanent magnet is an average value of thicknesses of the plurality of permanent magnets or is smaller than the average value, and
wherein the thickness of the second permanent magnet is larger than the average value of the thicknesses of the plurality of permanent magnets.

9. The rotor for a rotating electric machine according to claim 1, wherein the first permanent magnet and the second permanent magnet form magnetic poles different from each other.

10. The rotor for a rotating electric machine according to claim 1, wherein the first permanent magnet and the second permanent magnet form the same magnetic pole.

11. The rotor for a rotating electric machine according to claim 10, wherein the first permanent magnet and the second permanent magnet are arranged such that an operating point of the permanent magnet arranged on a delay side in a torque generation direction is higher than an operating point of the permanent magnet arranged on an advance side in the torque generation direction.

12. A method of manufacturing a rotor for a rotating electric machine, comprising:
a thickness dimension measuring step of measuring a dimension of each of a plurality of permanent magnets in a thickness direction;
a permanent magnet sorting step of sorting, after the thickness dimension measuring step, the permanent magnet having the dimension in the thickness direction which is within a range of a set tolerance and smaller than a set value as a first permanent magnet, and the permanent magnet having the dimension in the thickness direction which is within the range of the set tolerance and larger than the set value as a second permanent magnet; and
a permanent magnet inserting step of inserting, after the permanent magnet sorting step, the first permanent magnet into a first magnet insertion hole formed in a rotor core, and the second permanent magnet into a second magnet insertion hole formed in the rotor core and having a dimension in a width direction which is larger than a dimension of the first magnet insertion hole in the width direction.

13. The method of manufacturing a rotor for a rotating electric machine according to claim 12,
wherein, in the thickness dimension measuring step, an average value of the dimensions of the plurality of permanent magnets in the thickness direction is calculated based on the dimensions of the plurality of permanent magnets in the thickness direction, and
wherein, in the permanent magnet sorting step, the average value is used as the set value.
